(19) United States
(12) Patent Application Publication
(10) Pub. No.: US 2018/0328660 A1
(43) Pub. Date: Nov. 15, 2018

(54) METHODS FOR REMOVING IMPURITIES FROM PROCESS GAS STREAMS

(71) Applicant: Linde Aktiengesellschaft, Munich (DE)

(72) Inventor: Nicole RUMORE, Monmouth Junction, NJ (US)

(21) Appl. No.: 15/591,882

(22) Filed: May 10, 2017

(51) Int. Cl. F25J 3/08; B01D 53/00; B01D 53/26; F25J 3/06

(52) U.S. Cl. CPC F25J 3/08; B01D 53/002; F25J 2220/02; F25J 3/061; B01D 53/265

(57) ABSTRACT

Methods and systems for removing impurities (e.g. volatile organic compounds, water) from process gas streams, including condensing and freezing of the process gas stream, are provided herein.

### FIELD OF THE INVENTION

This invention relates to methods for removing impurities from various process gas streams.

### BACKGROUND OF THE INVENTION

In addition to valuable components in various process gas streams, impurities in varying concentrations typically may also be present, which require removal. For example, during pharmaceutical production processes or fine chemical production processes, valuable pharmaceutical product or fine chemical product may be present in process gas streams along with impurities, such as various solvents including volatile organic compounds (VOCs). Additionally, other process gas streams may comprise valuable nitrogen along with VOC impurities. VOCs are understood to present environmental and health hazards; thus, global regulations limit emissions of VOCs into the environment.

Current processes for removing impurities, such as VOCs, from process gas streams may involve cryogenic condensation processes using liquid nitrogen as a cooling medium. However, existing cryogenic condensation techniques may be limited in the amount of impurities removed and the process gas may require further processing, such as adsorption beds, in an attempt to achieve the regulation-mandated impurity reduction. Additionally, frozen impurity particles may occur on heat exchanger surfaces during cryogenic condensation. The can result in a reduction of surface area and potential increase in process gas velocity, which may lead to undesirable entrainment of frozen particles in the outlet gas.

Thus, a need remains for improved and more effective methods for removal of impurities from process gas streams.

### SUMMARY OF THE INVENTION

It has been found that impurities from process gas streams may be sufficiently removed to achieve purified gas streams having lower levels of impurities by performing a combination of process steps including cooling a process gas stream to remove a portion of the impurities via a condensate stream followed by freezing of the impurities in the process gas stream for further impurity removal.

Thus, in one aspect, this disclosure relates to a method for removing impurities from a process gas stream comprising: a process cycle comprising: cooling the process gas stream in at least one cooling apparatus under suitable conditions to produce a first condensate stream comprising a portion of the impurities and a cooled process gas stream having a temperature of less than −10° C.; freezing the impurities in the cooled process gas stream in at least one freezing apparatus under suitable conditions to produce a purified gas stream having a temperature of less than about −140° C.; and optionally, removing frozen impurity particles from the purified gas stream in at least one separation apparatus.

In still another aspect, this disclosure relates to a system for removing impurities from a process gas stream comprising: a process gas stream; a first condensate stream comprising at least a portion of the impurities; a cooled process gas stream having a temperature of less than −10° C.; a purified process gas stream having a temperature of less than about −140° C.; at least one cooling apparatus operated under suitable conditions to produce the first condensate stream comprising at least a portion of the impurities and the cooled process gas stream, wherein the at least one condenser comprises: a first inlet for providing the process gas stream; a first outlet for removal of the first condensate stream; and a second outlet for removal of the cooled process gas stream; and at least one freezing apparatus operated under suitable conditions to freeze at least a further portion of the impurities present in the cooled process gas stream to produce the purified gas stream, wherein the at least one freezing apparatus comprises: a second inlet for providing the cooled process gas stream; and a third outlet for removal of the purified gas stream; and a separator for removing frozen impurity particles from the purified gas stream.

Other embodiments, including particular aspects of the embodiments summarized above, will be evident from the detailed description that follows.

### BRIEF DESCRIPTION OF DRAWINGS

The drawings described herein are for illustrative purposes only of selected embodiments and not all possible implementations, and are not intended to limit the scope of the present disclosure.

FIG. 1 illustrates a schematic of a system for removing impurities from process gas streams according to certain aspects of the present disclosure.

FIG. 2 illustrates a schematic of a system for removing impurities from process gas streams according to certain alternative aspects of the present disclosure.

Corresponding reference numerals indicate corresponding parts throughout the several views of the drawings.

### DETAILED DESCRIPTION OF THE INVENTION

In various aspects of the invention, methods and systems for removing impurities from process gas streams are provided.

### I. Definitions

The term “and/or” as used in a phrase such as “A and/or B” herein is intended to include “A and B”, “A or B”, “A”, and “B”.

As used herein, the term “volatile organic compound (VOC)” refers to a carbon-containing compound which exists partially or completely in a gaseous state at a given temperature. The definition of volatile organic compound or VOC is intended to include organic compounds having a boiling point from about 50° C. to about 260° C. In Germany, an organic compound is referred to as volatile in the 31 BlmscV [31st Federal Emission Protection Ordinance] if it has a vapor pressure of at least 0.01 kPa at a temperature of 293.15 K or a corresponding volatility under the given conditions of use. The definition of volatile organic compound or VOC also encompasses compounds that break down to form ground level ozone and smog in the presence of sunlight. Further volatice organic compound or VOC includes compounds that are toxic, which are Toxic Substance Control Act regulated under (TSCA).

### II. Methods for Removing Impurities from Process Gas Streams

Methods for removing impurities from process gas streams are provided herein. The methods may comprise a process cycle including condensing and freezing of the impurities in the process gas stream as well as a defrost cycle.

A. Process Cycle

As discussed above, a process gas stream may comprise various impurities in addition to valuable components. For example, process gas streams, such as pharmaceutical or fine chemical process streams, may comprise impurities, such as solvents including VOCs in addition to valuable components. Alternatively, process gas streams may comprise valuable nitrogen components in addition to VOC impurities. Such impurities may not remain in the process gas stream because of regulations limiting the amount of VOC emissions. Thus, it is necessary to efficiently and effectively remove these impurities from the process gas stream to achieve clean process gas streams having sufficiently lower amount of impurities, particularly lower amounts of VOCs.

Therefore, in order to remove at least a portion of impurities present in a process gas stream, a process cycle is provided herein wherein a process gas stream may be cooled in at least one cooling apparatus under suitable conditions to produce a first condensate stream comprising at least a portion of the impurities and a cooled process gas stream. The first condensate stream may be collected in at least one condensate tank. Impurities contemplated herein include, but are not limited to VOCs and/or water. Examples of VOCs include, but are not limited to dichloromethane, chloromethane, ethyl ether, dimethyl ether, acetone, methanol, ethanol, benzene, phenol, toluene, 2-butatione, cyclohexane, methyl isobutyl ketone, tetrahydrofuran and combinations thereof.

In various aspects, the process gas stream may comprise impurities in an amount, based on the total weight of the process gas stream, of at least about 0.0040 wt %, at least about 0.010 wt %, at least about 0.10 wt %, at least about 1.0 wt %, at least about 10 wt %, at least about 20 wt %, at least about 30 wt %, at least about 40 wt %, at least about 50 wt %, at least about 60 wt %, at least about 70 wt %, at least about 80 wt %, or about 90 wt %. Additionally or alternatively, the process gas stream may comprise impurities in an amount, based on the total weight of the process gas stream, of about 0.0040 wt % to about 90 wt %, about 0.0040 wt % to about 70 wt %, about 0.010 wt % to about 90 wt %, about 0.010 wt % to about 70 wt %, about 0.10 wt % to about 90 wt %, about 0.10 wt % to about 70 wt %, about 10 wt % to about 90 wt %, about 10 wt % to about 80 wt %, about 10 wt % to about 70 wt %, about 10 wt % to about 60 wt %, about 10 wt % to about 50 wt %, about 10 wt?% to about 40 wt %, about 10 wt % to about 30 wt %, about 10 wt % to about 20 wt %, about 20 wt % to about 90 wt %, about 20 wt % to about 80 wt %, about 20 wt % to about 70 wt %, about 20 wt % to about 60 wt % , about 20 wt % to about 50 wt %, about 20 wt % to about 40 wt %, about 30 wt % to about 90 wt %, about 30 wt % to about 80 wt %, about 30 wt % to about 70 wt %, about 30 wt % to about 60 wt %, about 30 wt % to about 50 wt %, about 30 wt % to about 40 wt %, about 40 wt % to about 90 wt %, about 40 wt % to about 80 wt %, about 40 wt % to about 70 wt %, about 40 wt % to about 60 wt %, about 40 wt % to about 50 wt %, about 50 wt % to about 90 wt %, about 50 wt % to about 80 wt %, about 50 wt % to about 70 wt %, or about 50 wt % to about 60 wt %. It is understood herein that the amount of impurities provided herein corresponds to both a single impurity amount as well as combined amounts of impurities, if one or more are present. For example, impurities present in an amount of at least about 10 wt % encompasses a process stream comprising at least about 10 wt % dichloromethane as well as a process stream comprising at least about 10 wt % dichloromethane and chloromethane in combination.

A remaining portion, e.g., the balance, of the process gas stream may further comprise a remaining component, such as, but not limited to nitrogen. For example, the remaining component may be present in the process gas stream in an amount, based on the total weight of the process gas stream, of at least about 10 wt %, at least about 20 wt %, at least about 30 wt %, at least about 40 wt %, at least about 50 wt %, at least about 60 wt %, at least about 70 wt %, at least about 80 wt %, at least about 90 wt %, at least about 95 wt % or at least about 99 wt %. Additionally or alternatively, the valuable component may be present in the process gas stream in an amount, based on the total weight of the process gas stream, of about 10 wt % to about 99 wt %,about 10 wt % to about 90 wt %, about 10 wt % to about 80 wt %, about 10 wt % to about 70 wt %, about 10 wt % to about 60 wt %, about 10 wt % to about 50 wt %, about 10 wt % to about 40 wt %, about 10 wt % to about 30 wt %, about 10 wt % to about 20 wt %, about 20 wt % to about 90 wt %, about 20 wt % to about 80 wt %, about 20 wt % to about 70 wt %, about 20 wt % to about 60 wt %, about 20 wt % to about 50 wt %, about 20 wt % to about 40 wt %, about 30 wt % to about 90 wt %, about 30 wt % to about 80 wt %, about 30 wt % to about 70 wt %, about 30 wt % to about 60 wt %, about 30 wt % to about 50 wt %, about 30 wt % to about 40 wt %, about 40 wt % to about 90 wt %, about 40 wt % to about 80 wt %, about 40 wt % to about 70 wt %, about 40 wt % to about 60 wt %, about 40 wt % to about 50 wt %, about 50 wt % to about 90 wt %, about 50 wt % to about 80 wt %, about 50 wt % to about 70 wt %, or about 50 wt % to about 60 wt %.

In various aspects, the process gas stream may enter the at least one cooling apparatus at any suitable temperature and/or pressure, for example, as determined by previous process steps and conditions for producing the process gas stream. For example, the process gas stream may enter the at least one cooling apparatus at a temperature of at least about 0.0° C., at least about 5.0° C., at least about 10° C., at least about 15° C., at least about 20° C., at least about 25° C., at least about 30° C., at least about 35° C., at least about 40° C., at least about 45° C. or about 50° C. Additionally or alternatively, the process gas stream may enter the at least one cooling apparatus at a temperature of about 0.0° C. to about 50° C., about 5.0° C. to about 50° C., about 10° C. to about 45° C., about 15° C. to about 40° C., or about 15° C. to about 35° C. Additionally, the process gas stream may enter the at least one cooling apparatus at a pressure, optionally in combination with the above-described temperatures, of at least about 80 kPa, at least about 90 kPa, at least about 100 kPa, at least about 110 kPa, at least about 120 kPa, at least about 150 kPa, at least about 180 kPa or about 200 kPa. For example, the process gas stream may enter the at least one condenser vessel at a pressure, optionally in combination with the above-described temperatures, of about 80 kPa to about 200 kPa, about 90 kPa to about 150 kPa or about 90 kPa to about 110 kPa. In particular, the process gas stream may enter the at least one cooling apparatus at a temperature of at least about 15° C. and a pressure of at least about 90 kPa.

In order to produce the first condensate stream, a cooling medium may be circulated through the at least one cooling apparatus at a temperature suitable for condensing at least a portion of the impurities present in the process gas stream to produce the first condensate stream comprising at least a portion of the impurities and the cooled process gas stream, which may exit the at least one cooling apparatus. Thus, the cooled process gas stream may have impurities present in an amount less than an amount of impurities present in the process gas stream entering the at least one cooling apparatus. For example, the process gas stream may have impurities present in an amount of less than or equal to about 1000 mg/m³, less than or equal to about 900 mg/m³, less than or equal to about 800 mg/m³, less than or equal to about 700 mg/m³, less than or equal to about 600 mg/m³, less than or equal to about 500 mg/m³, less than or equal to about 400 mg/m³, less than or equal to about 300 mg/m³, less than or equal to about 250 mg/m³, less than or equal to about 225 mg/m³, less than or equal to about 200 mg/m³, less than or equal to about 175 mg/m³, less than or equal to about 150 mg/m³, less than or equal to about 125 mg/m³, less than or equal to about 100 mg/m³, less than or equal to about 70 mg/m³, or about 40 mg/m³. In particular, the amount of impurities present in the cooled process gas stream may be less than about 1000 mg/m³. Additionally or alternatively, the process gas stream may have impurities present in an amount about 40 mg/m³ to about 1000 mg/m³, about 70 mg/m³ to about 800 mg/m³, about 100 mg/m³ to about 500 mg/m³ or about 100 mg/m³ to about 300 mg/m³.

A suitable cooling medium includes, but is not limited to, liquid nitrogen and/or gaseous nitrogen. The cooling medium (e.g., gaseous and/or liquid nitrogen) may be provided and/or circulated in the cooling apparatus at a temperature of at least about −196° C., at least about −190° C., at least about −180° C., at least about −170° C., at least about −160° C., or at least about −150° C. For example, the cooling medium (e.g., liquid and/or gaseous nitrogen) may be provided and/or circulated in the cooling apparatus at a temperature of about −196° C. to about −150° C., about −190° C. to about −150° C., or about −180° C. to about −160° C. Additionally, the cooling medium, gaseous and/or liquid nitrogen) may be provided and/or circulated in the cooling apparatus, optionally in combination with the above-described temperatures, at a pressure less than or equal to about 1600 kPa, less than or equal to about 1500 kPa, less than or equal to about 1300 kPa, less than or equal to about 1200 kPa, less than or equal to about 1000 kPa, less than or equal to about 800 kPa, less than or equal to about 700 kPa, less than or equal to about 500 kPa, less than or equal to about 300 kPa, or about 100 kPa. For example, the cooling medium (e.g., liquid and/or gaseous nitrogen) may be provided and/or circulated in the cooling apparatus, optionally in combination with the above-described temperatures, at a pressure of about 100 kPa to about 1600 kPa, about 300 kPa to about 1500 kPa, about 500 kPa to about 1500 kPa, about 700 kPa to about 1300 kPa or about 800 kPa to about 1200 kPa. In particular, the cooling medium (e.g., liquid and/or gaseous nitrogen) may be provided and/or circulated in the cooling apparatus at a temperature of at least about −196° C. and/or at a pressure of less than or equal to about 1500 kPa (e.g., about −170° C. and about 1000 kPa). Examples of a suitable cooling apparatus include, but are not limited to, heat exchangers, such as a coil heat exchanger, a shell and tube heat exchanger and a plate heat exchanger.

As a result, the cooled process gas stream may have a temperature of less than or equal to about 0.0° C., less than or equal to about −10° C., less than or equal to about −20° C., less than or equal to about −30° C., less than or equal to about −40° C. less than or equal to about −50° C., less than or equal to about −60° C., less than or equal to about −70° C., less than or equal to about −80° C., less than or equal to about −90° C., less than or equal to about −100° C., less than or equal to about −110° C., less than or equal to about −1.20° C., less than or equal to about −130° C., less than or equal to about −140° C., or about −150° C. In particular, the cooled process gas stream may have a temperature of less than −10° C. Additionally or alternatively, the cooled process gas stream may have a temperature of about −150° C. to about −0.0° C., about −150° C. to about −10° C., about −140° C. to about −20° C., about −130° C. to about −30° C., about −120° C. to about −40° C. or about −110° C. to about −50° C.

In order to remove at least a portion of the remaining impurities in the cooled process gas stream, the process cycle may further comprise freezing the impurities in the cooled process gas stream in at least one freezing apparatus under suitable conditions to produce a purified gas stream. A cooling medium may be circulated through the at least one freezing apparatus at a temperature suitable for freezing at least a portion of the impurities present in the cooled process gas stream to produce frozen impurity particles within the at least one freezing apparatus and a purified gas stream, which may exit the at least one freezing apparatus. It also contemplated herein, that a condensate comprising impurities may also be formed during freezing. Thus, the purified process gas stream may have impurities present in an amount less than an amount of impurities present in the cooled process gas stream entering the at least one freezing apparatus. For example, an amount of impurities (e.g., VOCs) present in the purified process gas stream may be less than or equal to about 100 mg/m³, less than or equal to about 90 mg/m³, less than or equal to about 80 mg/m³, less than or equal to about 70 mg/m³, less than or equal to about 60 mg/m³, less than or equal to about 50 mg/m³, less than or equal to about 40 mg/m³, less than or equal to about 30 mg/m³, less than or equal to about 20 mg/m³, less than or equal to about 10 mg/m³, or about 5.0 mg/m³. In particular, the amount of impurities (e.g., VOCs) present in the purified process gas stream may be less than about 20 mg/m³. Additionally or alternatively, the process gas stream may have impurities (e.g., VOCs) present in an amount about 5.0 mg/m³ to about 100 mg/m³, about 5.0 mg/m³ to about 80 mg/m³, about 5.0 mg/m³ to about 50 mg/m³, about 5.0 mg/m³ to about 30 mg/m³, or about 10 mg/m³ to about 30 mg/m³.

A suitable cooling medium includes, but is not limited to liquid nitrogen and/or gaseous nitrogen. The cooling medium (e.g., gaseous and/or liquid nitrogen) may be provided and/or circulated in the freezing apparatus at a temperature of at least about −210° C., at least about −196° C., at least about −190° C., at least about −180° C., at least about −170° C., at least about −160° C., or at least about −150° C. For example, the cooling medium (e.g., liquid and/or gaseous nitrogen) may be provided and/or circulated in the freezing apparatus at a temperature of about −196° C. to about −150° C., about −190° C. to about −150° C., or about −180° C. to about −160° C. Additionally, the cooling medium (e.g., gaseous and/or liquid nitrogen) may be provided and/or circulated in the freezing apparatus, optionally in combination with the above-described temperatures, at a pressure of less than or equal to about 1600 kPa, less than or equal to about 1500 kPa, less than or equal to about 1300 kPa, less than or equal to about 1200 kPa, less than or equal to about 1000 kPa, less than or equal to about 800 kPa, less than or equal to about 700 kPa, less than or equal to about 500 kPa, less than or equal to about 300 kPa, or about 100 kPa. For example, the cooling medium (e.g., liquid and/or gaseous nitrogen) may be provided and/or circulated in the freezing apparatus, optionally in combination with the above-described temperatures, at a pressure of about 100 kPa to about 1600 kPa, about 300 kPa to about 1500 kPa, about 500 kPa to about 1500 kPa, about 700 kPa to about 1300 kPa or about 800 kPa to about 1200 kPa. In particular, the cooling medium (e.g., liquid and/or gaseous nitrogen) may be provided and/or circulated at a temperature of at least about −196° C. and/or at a pressure of less than or equal to about 1500 kPa (e.g., about −170° C. and about 1000 kPa). Examples of a suitable freezing apparatus include, but are not limited to heat exchangers, such as a coil heat exchanger, a shell and tube heat exchanger and a plate eat exchanger. In particular, the cooling means may be a plate heat exchanger.

As a result, the purified process gas stream may have a temperature of less than or equal to about −110° C., less than or equal to about −125° C., less than or equal to about −140° C., less than or equal to about −150° C., less than or equal to about −160° C. In particular, the cooled process gas stream may have a temperature of less than about −140° C. Additionally or alternatively, the purified process gas stream may have a temperature of about −160° C. to about −110° C., about −160° C. to about −125° C., or about −160° C. to about −150° C.

In various aspects, a lower pressure drop may be maintained within the at least one freezing apparatus. For example, in the at least one freezing apparatus, the pressure drop may be less than about 20 kPa, less than about 15 kPa, less than about 10 kPa, less than about 7 kPa or about 5.0 kPa. In particular, in the at least one freezing apparatus, the pressure drop may be less than about 10 kPa. As frozen impurities accumulate within the at least one freezing apparatus, for example, on the surface (e.g., plates) of a heat exchanger, the pressure drop within the at least one freezing apparatus may increase. In certain aspects, the process cycle may be halted once the pressure drop in the at least one freezing apparatus reaches a predetermined value as necessitated by the process conditions, for example, a pressure drop greater than about 10 kPa, greater than about 12 kPa or greater than about 1.5 kPa.

As the process cycle runs, frozen impurity particles may become entrained in the purified gas stream, for example, due to increased frozen impurity particle accumulation within the freezing apparatus as described herein and associated increase in velocity of the cooled process gas stream and/or purified gas process stream. Thus, the process cycle may optionally further comprise removing any frozen impurity particles from the purified gas stream in at least one separation apparatus. Any suitable separation apparatus may be used to remove the frozen impurity particles including, but not limited to a cyclone and/or a filter comprising an adsorbent material. Non-limiting examples of suitable adsorbent material include activated carbon, zeolites, activated aluminum oxides and combinations thereof.

In various aspects, the process cycle may run for about 1.0 hour to about 96 hours, about 3.0 hour to about 84 hours, about 3.0 hours to about 72 hours, about 6.0 hours to about 60 hours or about 6.0 to about 24 hours. In particular, the process cycle may run for about 3.0 hours to about 72 hours, preferably about 6.0 to about 24 hours.

B. Defrost Cycle

The methods described herein may further comprise a defrost cycle to melt frozen impurities in the at least one cooling apparatus and/or in the at least one freezing apparatus. The defrost cycle may be performed as needed by the process, for example, when pressure drop exceeds a predetermined value as described herein. The defrost cycle may comprise halting the process gas stream to the at least one cooling apparatus and/or halting the cooled process gas stream to the at least one freezing apparatus. The cooling medium to the at least one cooling apparatus and/or the at least one freezing apparatus may also be halted. The defrost cycle may further comprise heating the at least one cooling apparatus to produce a second condensate stream comprising water and/or impurities and heating the at least one freezing apparatus to produce a third condensate stream comprising water and/or impurities. The heating of the cooling apparatus and/or the freezing apparatus may be provided by any suitable heating means for defrosting the cooling apparatus and/or the freezing apparatus. Optionally, the separation apparatus may be heated as well to melt frozen impurity particles and to form a fourth condensate stream. For example, the heating means may include by heated gaseous nitrogen, an electric heater, and/or heated air. The gaseous nitrogen and/or air may be heated to a suitable temperature (e.g., greater than about −50° C. up to about 25° C.) prior to introduction into the cooling apparatus and/or the freezing apparatus. The defrost cycle may further comprise draining the second condensate stream from the at least one cooling apparatus, draining the third condensate stream from the at least one freezing apparatus and/or draining the fourth condensate stream from the separation apparatus to collect in the at least one condensate.

In various aspects, the defrost cycle may run for about 1.0 hour to about 18 hours, about 1.0 hour to about 12 hours, about 1.0 hour to about 6.0 hours, about 1.0 hour to about 3.0 hours, or about 1.0 hour to about 2.0 hours. In particular, the defrost cycle may run for about 1.0 hour to about 3.0 hours, preferably about 1 hour to about 2.0 hours.

It is further contemplated herein, that the process cycle and the defrost cycle may run in parallel in two or more cooling apparatuses and/or two or more freezing apparatuses, which may be in series.

### III. Systems for Removing Impurities from Process Gas Streams

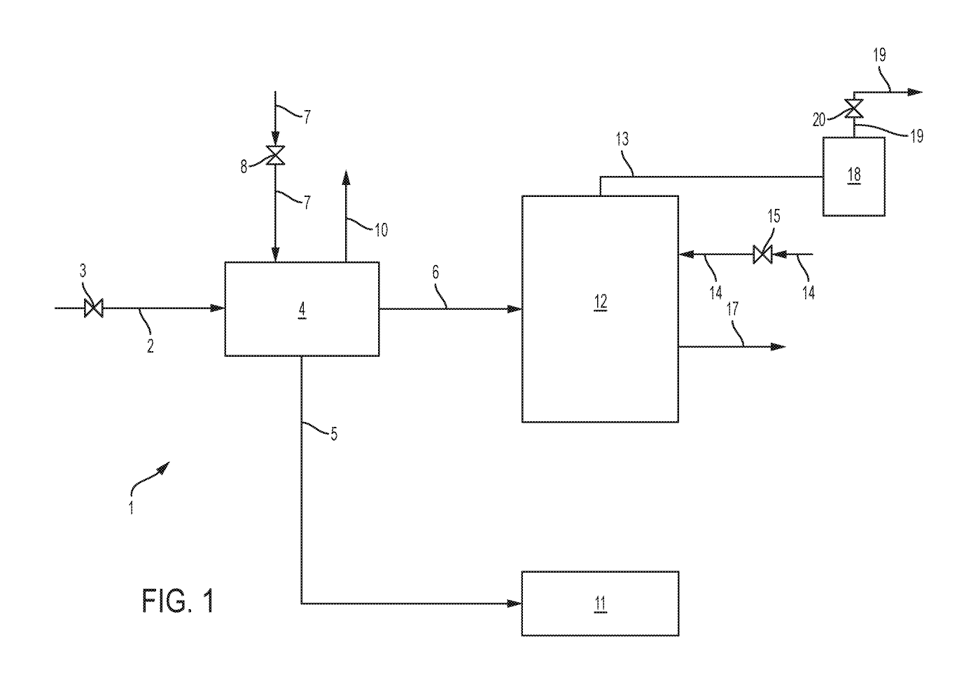

Systems for removing impurities from a process gas stream as described herein are also provided. Referring to FIG. 1, the system 1 may comprise a process gas stream 2 as described herein, which is provided to at least one cooling apparatus 4 via a first inlet (not shown), for example, during a process cycle as described herein, wherein a first condensate stream 5 and a cooled process gas stream 6 are produced. In particular, the process gas stream 2 may comprise impurities as described herein (e.g., VOCs) and at least one valuable or recoverable component as described herein. A valve 3 may control the flow of process gas stream 2 into the cooling apparatus 4.

Additionally, in order to produce the first condensate stream 5 as described herein and the cooled process gas stream 6 as described herein (e.g., having a temperature of less than −10° C.), the system 1 may further comprise a first cooling medium stream 7 provided via a third inlet (not shown) and controlled by a valve 8, which may be circulated through the at least one cooling apparatus 4 (e.g., shell and tube heat exchanger, plate heat exchanger, coil heat exchanger), at a temperature suitable for condensing at least a portion of the impurities (e.g., VOCs) present in the process gas stream 2 to produce the first condensate stream 5 comprising impurities (e.g., VOCs). The first cooling medium stream 7 may comprise a suitable cooling medium as described herein, for example, liquid nitrogen and/or gaseous nitrogen. As the first cooling medium stream 7 (e.g., gaseous and/or liquid nitrogen) circulates through the cooling apparatus 4, it may be heated and exit the system 1 as a first spent cooling medium stream 10 via a fourth outlet (not shown). Additionally or alternatively, a valve (not shown) may be present on first spent cooling medium stream 10 for controlling the cooling medium circulating through the at least one cooling apparatus 4. In various aspects, at least a portion of the first spent cooling medium stream 10 may comprise gaseous nitrogen.

At least one condensate tank 11 may be present in the system 1 for collection of the first condensate stream 5, which may be removed via a first outlet (not shown) in the cooling apparatus 4, for example, as the first condensate stream 5 drains from the at least one cooling apparatus 4 during the process cycle as described herein. The at least one condensate tank 11 may comprise a fifth inlet (not shown) for providing the first condensate stream 5.

In order to remove further impurities, the system 1 may further comprise at least one freezing apparatus 12. The cooled process gas stream 6 may exit the cooling apparatus 4 via a second outlet (not shown) and enter the freezing apparatus 12 via a second inlet (not shown). The freezing apparatus 12 may be operated under suitable conditions to freeze at least a further portion of the impurities present in the cooled process gas stream 6 to produce a purified gas stream 13, which may exit the freezing apparatus 12 via a third outlet (not shown). In order to produce the purified process gas stream 13, the system 1 may further comprise a second cooling medium stream 14 provided via a fourth inlet (not shown) and controlled by a valve 15, which may be circulated through the at least one freezing apparatus 12 (e.g., shell and tube heat exchanger, plate heat exchanger, coil heat exchanger), at a temperature suitable for freezing at least a portion of the impurities (e.g., VOCs) present in the cooled process gas stream 6 to produce frozen impurity (e.g., VOCs) particles within the freezing apparatus 12 and the purified gas process stream 13. In particular, the purified gas stream 13 may, for example, have a temperature of less than about −140° C. and/or have impurities (e,g., VOCs) in an amount of less than about 20 mg/m³. A condensate (not shown) comprising at least a portion of the impurities (e.g., VOCs) may also form and be present in the freezing apparatus 12. The second cooling medium stream 14 may comprise a suitable cooling medium as described herein, for example, liquid nitrogen and/or gaseous nitrogen. As the second cooling medium stream 14 (e.g., gaseous and/or liquid nitrogen) circulates through the freezing apparatus 12, it may be heated and exit the system 1 as a second spent cooling medium stream 17 via a fifth outlet (not shown). Additionally or alternatively, a valve (not shown) may be present on second spent cooling medium stream 17 for controlling the cooling medium circulating through the at least one freezing apparatus 12. In various aspects, at least a portion of the second spent cooling medium stream 17 may comprise gaseous nitrogen.

As described above, frozen impurity particles may become entrained with the purified process gas stream 13 during the process cycle. Thus, system 1 may further comprise a separator 18 for removing the frozen impurity particles from the purified process gas stream 13 to produce a purified gas stream with reduced solids stream 19. The separator 18 may be any suitable separator as described herein, for example, a cyclone or a filter comprising an adsorbent.

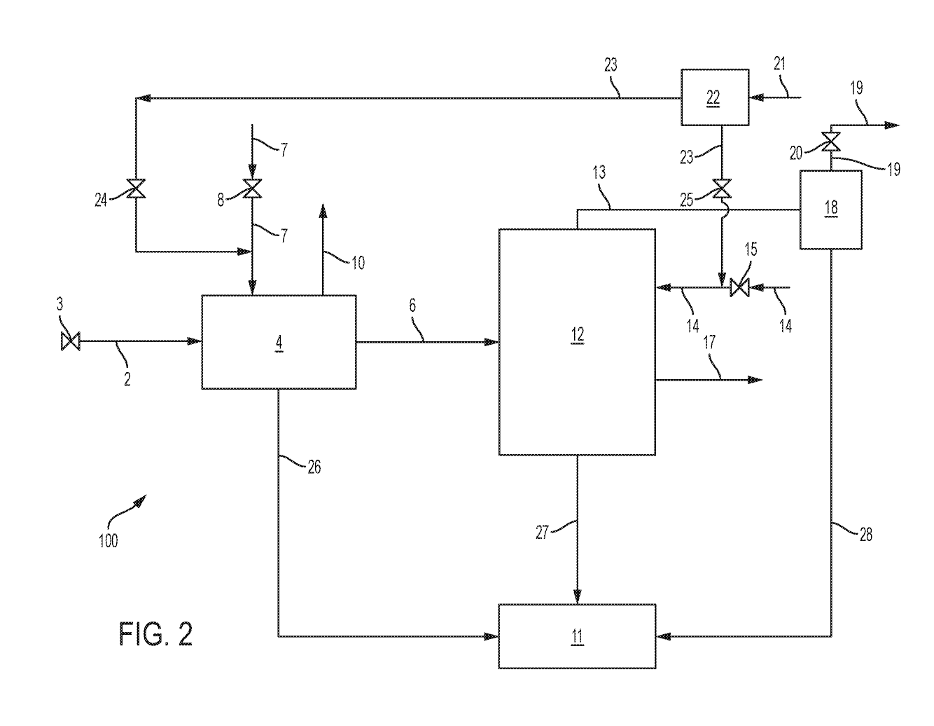

Optionally, as shown in FIG. 2, the system 1 may further comprise a gaseous nitrogen stream 21 and a means for providing heat 22 (e.g., electric heater) for producing a heated gaseous nitrogen stream 23, which may be introduced into the cooling apparatus 4 as controlled by a valve 24 and/or into the freezing apparatus 12 as controlled by valve 25, for example, during a defrost cycle as described herein wherein valve 20 may be closed as well. Alternatively, heated air or an electric heater may be used to heat the cooling apparatus 4 and/or freezing apparatus 12. Further, during a defrost cycle as described herein, a second condensate stream 26 as described herein comprising impurities and a third condensate stream 27 as described herein comprising impurities may be produced when the cooling apparatus 4 and/or the freezing apparatus 12 are heated. Optionally, a fourth condensate stream 28 may be produced when frozen impurity particles melt in the separator 18, optionally after application of heat. The second condensate stream 26, the third condensate stream 27, and/or the fourth condensate stream 28 may be collected in condensate tank 11.

It is contemplated herein that the valves, streams, etc., shown in FIGS. 1 and 2 are not limited to the locations as shown in FIGS. 1 and 2, but may be present in the systems, as desired and needed by the requirements of the process. For example, valve 8 may be present on any suitable location on first cooling medium stream 7 including near or at the near or at the third inlet (not shown) of the at least one cooling apparatus 4.

### IV. Further Embodiments

The invention can additionally or alternatively include one or more of the following embodiments.

Embodiment 1. A method for removing impurities (e.g., VOCs and/or water) from a process gas stream comprising: a process cycle comprising: cooling the process gas stream in at least one cooling apparatus under suitable conditions to produce a first condensate stream comprising a portion of the impurities (e.g., VOCs and/or water) and a cooled process gas stream having a temperature of less than −10° C.; freezing the impurities (e.g., VOCs and/or water) in the cooled process gas stream in at least one freezing apparatus under suitable conditions to produce a purified gas stream having a temperature of less than about −140° C.; and optionally, removing frozen impurity (e.g., VOCs and/or water) particles from the purified gas stream in at least one separation apparatus (e.g., cyclone, a filter comprising an adsorbent).

Embodiment 2. The method of embodiment 1, wherein the amount of the impurities present in the cooled process gas stream is less than about 1000 mg/m³ and/or the amount of the impurities present in the purified gas stream is less than about 20 mg/m³ of volatile organic compounds.

Embodiment 3. The method of any one of the previous embodiments, wherein liquid nitrogen and/or gaseous nitrogen provides cooling to the at least one cooling apparatus and freezing to the at least one freezing apparatus.

Embodiment 4. The method of any one of the previous embodiments, wherein the pressure drop is less than about 10 kPa in the at least one freezing apparatus.

Embodiment 5. The method of any one of the previous embodiments, wherein the at least one cooling apparatus and the at least one freezing apparatus each independently comprise a heat exchanger, e.g., selected from the group consisting of a shell and tube heat exchanger, a plate heat exchanger, a coil heat exchanger and a spiral heat exchanger.

Embodiment 6. The method of any one of the previous embodiments, wherein the process cycle is halted once the pressure drop in the at least one freezing apparatus is greater than 10 kPa.

Embodiment 7. The method of any one of the previous embodiments further comprising a defrost cycle comprising: halting the process gas stream to the at least one cooling apparatus and halting the cooled process gas stream to the at least one freezing apparatus; heating the at least one cooling apparatus to produce a second condensate stream comprising the impurities; and heating the at least one freezing apparatus to produce a third condensate stream comprising the impurities.

Embodiment 8. The method of embodiment 7, wherein the heating of the at least one cooling apparatus and the at least one freezing apparatus is provided by gaseous nitrogen.

Embodiment 9. The method of embodiment 7 or 8, wherein the first condensate stream, the second condensate stream, and the third condensate stream are collected in at least one condensate tank.

Embodiment 10. The method of any one of embodiments 7, 8, or 9, wherein the process cycle runs for about 3.0 to about 72 hours and/or the defrost cycle runs for about 1.0 hour to about 3.0 hours.

Embodiment 11. The method of any one of embodiments 7, 8, 9 or 10, where the process cycle and the defrost cycle are running in parallel in two or more cooling apparatuses and two or more freezing apparatuses.

Embodiment 12. A system for removing impurities (e.g., VOCs and/or water) from a process gas stream comprising: a process gas stream; a first condensate stream comprising at least a portion of the impurities (e.g., VOCs and/or water); a cooled process gas stream having a temperature of less than −10° C.; a purified process gas stream having a temperature of less than about −140° C.; at least one cooling apparatus operated under suitable conditions to produce the first condensate stream comprising at least a portion of the impurities (e.g., VOCs and/or water) and the cooled process gas stream, wherein the at least one condenser comprises: a first inlet for providing the process gas stream; a first outlet for removal of the first condensate stream; and a second outlet for removal of the cooled process gas stream; and at least one freezing apparatus operated under suitable conditions to freeze at least a further portion of the impurities (e.g., VOCs and/or water) present in the cooled process gas stream to produce the purified gas stream, wherein the at least one freezing apparatus comprises: a second inlet for providing the cooled process gas stream; and a third outlet for removal of the purified gas stream; and a separator for removing frozen impurity (e.g., VOCs and/or water) particles from the purified gas stream.

Embodiment 13. The system of embodiment 12, wherein the amount of the impurities present in the purified gas stream is less than about 20 mg/m³ of volatile organic compounds.

Embodiment 14. The system of embodiment 12 or 13, wherein the at least one cooling apparatus and the at least one freezing apparatus each independently comprise a heat exchanger, e.g., selected from the group consisting of a shell and tube heat exchanger, a plate heat exchanger, a coil heat exchanger and a spiral heat exchanger.

Embodiment 15. The system of any one of embodiments 12, 13 or 14 further comprising a first cooling medium stream and/or a second cooling medium stream, wherein the at least one cooling apparatus further comprises a third inlet for providing the first cooling medium stream for condensation and/or the at least one freezing apparatus further comprises a fourth inlet for providing the second cooling medium stream for freezing.

What is claimed is:

1. A method for removing impurities from a process gas stream comprising:
a process cycle comprising:
cooling the process gas stream in at least one cooling apparatus under suitable conditions to produce a first condensate stream comprising a portion of the impurities and a cooled process gas stream having a temperature of less than −10° C.;
freezing the impurities in the cooled process gas stream in at least one freezing apparatus under suitable conditions to produce a purified gas stream having a temperature of less than about −140° C.; and
optionally, removing frozen impurity particles from the purified gas stream in at least one separation apparatus.

2. The method of claim 1, wherein the amount of the impurities present in the cooled process gas stream is less than about 1000 mg/m³.

3. The method of claim 1, wherein the impurities are volatile organic compounds and/or water.

4. The method of claim 3, wherein the amount of the impurities present in the purified gas stream is less than about 20 mg/m³ of volatile organic compounds.

5. The method of claim 1, wherein liquid nitrogen and/or gaseous nitrogen provides cooling to the at least one cooling apparatus and freezing to the at least one freezing apparatus.

6. The method of claim 1, wherein the pressure drop is less than about 10 kPa in the at least one freezing apparatus.

7. The method of claim 1, wherein the at least one cooling apparatus and the at least one freezing apparatus each independently comprise a heat exchanger.

8. The method of claim 7, wherein the heat exchanger is selected from the group consisting of a shell and tube heat exchanger, a plate heat exchanger, a coil heat exchanger and a spiral heat exchanger.

9. The method of claim 1, wherein the at least one separation apparatus is a cyclone or a filter comprising an adsorbent.

10. The method of claim 1, wherein the process cycle is halted once the pressure drop in the at least one freezing apparatus is greater than 10 kPa.

11. The method of claim 1 further comprising a defrost cycle comprising
halting the process gas stream to the at least one cooling apparatus and halting the cooled process gas stream to the at least one freezing apparatus;
heating the at least one cooling apparatus to produce a second condensate stream comprising the impurities; and
heating the at least one freezing apparatus to produce a third condensate stream comprising the impurities.

12. The method of claim 11, wherein the heating of the at least one cooling apparatus and the at least one freezing apparatus is provided by gaseous nitrogen.

13. The method of claim 11, wherein the first condensate stream, the second condensate stream, and the third condensate stream are collected in at least one condensate tank.

14. The method of claim 11, wherein the process cycle runs for about 3.0 to about 72 hours and/or the defrost cycle runs for about 1.0 hour to about 3.0 hours.

15. The method of claim 11, wherein the process cycle and the defrost cycle are running in parallel in two or more cooling apparatuses and two or more freezing apparatuses.

16. A system for removing impurities from a process gas stream comprising:
a process gas stream;
a first condensate stream comprising at least a portion of the impurities;
a cooled process gas stream having a temperature of less than −10° C.;
a purified process gas stream having a temperature of less than about −140° C.;
at least one cooling apparatus operated under suitable conditions to produce the first condensate stream comprising at least a portion of the impurities and the cooled process gas stream, wherein the at least one condenser comprises:
a first inlet for providing the process gas stream;
a first outlet for removal of the first condensate stream; and
a second outlet for removal of the cooled process gas stream; and
at least one freezing apparatus operated under suitable conditions to freeze at least a further portion of the impurities present in the cooled process gas stream to produce the purified gas stream, wherein the at least one freezing apparatus comprises:
a second inlet for providing the cooled process gas stream; and
a third outlet for removal of the purified gas stream;
and a separator for removing frozen impurity particles from the purified gas stream

17. The system of claim 16, wherein the impurities are volatile organic compounds and/or water.

18. The system of claim 17, wherein the amount of the impurities present in the purified gas stream is less than about 20 mg/m³ of volatile organic compounds.

18. The system of claim 15, wherein the at least one cooling apparatus and the at least one freezing apparatus each independently comprise a heat exchanger.

19. The system of claim 18, wherein the heat exchanger is selected from the group consisting of a shell and tube heat exchanger, a plate heat exchanger, a coil heat exchanger and a spiral heat exchanger.

20. The system of claim 15 further comprising a first cooling medium stream, wherein the at least one cooling apparatus further comprises a third inlet for providing the first cooling medium stream for condensation.

21. The system of claim 15 further comprising a second cooling medium stream, wherein the at least one freezing apparatus further comprises a fourth inlet for providing the second cooling medium stream for freezing.
